(19) United States
(12) Patent Application Publication
(10) Pub. No.: US 2026/0036861 A1
(43) Pub. Date: Feb. 5, 2026

(54) LIQUID CRYSTAL ELEMENT, DISPLAY DEVICE, AND DIMMER DEVICE

(71) Applicant: Murata Manufacturing Co., Ltd., Nagaokakyo-shi (JP)

(72) Inventors: Masashi UEBE, Nagaokakyo-shi (JP); Nako KIMURA, Nagaokakyo-shi (JP)

(21) Appl. No.: 19/357,283

(22) Filed: Oct. 14, 2025

Related U.S. Application Data
(63) Continuation of application No. PCT/JP2024/014082, filed on Apr. 5, 2024.

(30) Foreign Application Priority Data
Apr. 17, 2023 (JP) 2023-066923

(51) Int. Cl. G02F 1/155; G02F 1/1343; G02F 1/139; G02F 1/153; G02F 1/29

(52) U.S. Cl. CPC G02F 1/155; G02F 1/134309; G02F 1/1391; G02F 1/1533; G02F 1/291; G02F 2001/1536; G02F 2001/1555

(57) ABSTRACT

A liquid crystal element that includes: a liquid crystal composition layer containing: a chiral agent capable of oxidation-reduction reaction, a liquid crystalline compound, and an electrolyte; a counter electrode material layer containing a substance capable of an oxidation-reduction reaction, a reverse reaction suppressing layer between the liquid crystal composition layer from the counter electrode material layer, the reverse reaction suppressing layer suppressing the reverse reaction of oxidation-reduction reaction; a first electrode in electrical contact with the counter electrode material layer; and a second electrode in electrical contact with the liquid crystal composition layer.

### CROSS REFERENCE TO RELATED APPLICATIONS

The present application is a continuation of International application No. PCT/JP2024/014082, filed Apr. 5, 2024, which claims priority to Japanese Patent Application No. 2023-066923, filed Apr. 17, 2023, the entire contents of each of which are incorporated herein by reference.

### TECHNICAL FIELD

The present disclosure relates to a liquid crystal element, a display device, and a dimmer device.

### BACKGROUND ART

A liquid crystal display device is used in not only personal computers and televisions but also various places. The liquid crystal display device uses a backlight which holds the key to lower power consumption of the device. A cholesteric liquid crystal is a liquid crystal capable of selective light reflection, and a reflective display using this liquid crystal is a device capable of controlling light with low power consumption. For example, Japanese Unexamined Patent Application Publication No. 2019-151597 and J. Am. Chem. Soc., 2018, 140, 10946 propose that a compound containing ferrocene introduced, as an oxidation-reduction site, in a binaphthyl skeleton serving as a chiral site is used as a chiral dopant which forms a cholesteric liquid crystal. Further, it is described that the reflection wavelength of a cholesteric liquid crystal can be controlled by using oxidation-reduction reaction due to voltage application to a liquid crystal composition layer containing a chiral dopant in which ferrocene is introduced.

### SUMMARY OF THE DISCLOSURE

According to an aspect of the present disclosure, an object is to provide a liquid crystal element having a memory property for reflected color.

According to a first aspect, a liquid crystal element includes: a liquid crystal composition layer containing: a chiral agent capable of oxidation-reduction reaction, a liquid crystalline compound, and an electrolyte; a counter electrode material layer containing a substance capable of an oxidation-reduction reaction, a reverse reaction suppressing layer between the liquid crystal composition layer from the counter electrode material layer, the reverse reaction suppressing layer suppressing the reverse reaction of oxidation-reduction reaction; a first electrode in electrical contact with the counter electrode material layer; and a second electrode in electrical contact with the liquid crystal composition layer.

A second aspect relates to a display device and a dimmer device each including the liquid crystal element according to the first aspect.

According to an aspect of the present disclosure, a liquid crystal element having a memory property for reflected color can be provided.

### BRIEF DESCRIPTION OF THE DRAWINGS

FIG. 1 is a schematic sectional view showing an example of the configuration of a liquid crystal element.

FIG. 2 is a schematic sectional view showing another example of the configuration of a liquid crystal element.

FIG. 3 is a diagram showing changes in transmission spectra of a liquid crystal element according to Example 1.

FIG. 4 is a diagram showing changes over time in transmittance of a liquid crystal element according to Example 1.

FIG. 5 is a diagram showing changes over time in transmittance of a liquid crystal element according to Comparative Example 1.

### DESCRIPTION OF THE PREFERRED EMBODIMENTS

In the present specification, the term “process” includes not only an independent process but also even a process which cannot be distinguished from other processes if the intended purpose of the process is achieved. When there are plural substances corresponding to each of the components in a composition, the content of each component in the composition represents a total amount of the plural substances present in the composition. Further, the upper limit and lower limit of a numerical range described in the present specification may be a combination of properly selected from the values exemplified as the numerical range. In the present specification, when a portion such as a layer, a film, a region, a plate or the like is located “on” or “above” another portion, this includes not only when the portion is located directly above another portion but also when still another portion is located in the middle. Conversely, when a portion such as a layer, a film, a region, a plate or the like is located “under” or “below” another portion, this includes not only when the portion is located directly below another portion but also when still another portion is located in the middle. Also, in the present specification, the expression “disposed on” includes not only when disposed above but also when disposed below.

An embodiment of the present disclosure is described based on the drawings. However, the embodiment described below shows an example of a liquid crystal element for embodying the technical idea of the present disclosure, and the present disclosure is not limited to the liquid crystal element described below. In addition, a member described in the claims is never limited to a member of the embodiment. In particular, the dimensions, material, shape, relative arrangement, and the like of the constituent component described in the embodiment are not for the purpose of limiting the range of the present disclosure only to them unless otherwise specified, and are just examples of description. In addition, the size, positional relation, and the like of a member shown in each of the drawings may be exaggerated for clear description. Further, in the description below, the same name and reference numeral denote the same or equivalent member, and detail description may be properly omitted. Further, with respect to each of the elements constituting the present disclosure, plural elements may be composed of the same member in a form in which plural elements are used for one member, and conversely the function of one member can be realized by sharing the function among plural members. Also, some of the contents described in some examples and embodiments can be used in other examples and embodiments.

### Liquid Crystal Element

A liquid crystal element includes a liquid crystal composition layer containing a chiral agent capable of oxidation-reduction reaction, a liquid crystalline compound, and an electrolyte, a counter electrode material layer containing a substance capable of oxidation-reduction reaction, a reverse reaction suppressing layer which suppresses the reverse reaction of oxidation-reduction reaction, a first electrode, and a second electrode. In the liquid crystal element, the reverse reaction suppressing layer separates the liquid crystal composition layer from the counter electrode material layer. The liquid crystal element may further include a pair of substrates which holds the liquid crystal composition layer, the reverse reaction suppressing layer, and the counter electrode material layer. If required, the liquid crystal element may further include a black plate, an antireflection film, a brightness enhancement film, and the like.

In the liquid crystal element including the liquid crystal composition layer containing the chiral agent capable of oxidation-reduction reaction, and the counter electrode material layer, applying a voltage causes oxidation-reduction reaction of the chiral agent with the substance capable of oxidation-reduction reaction contained in the counter electrode material layer, and thus the period (pitch) of a helical structure formed by the liquid crystal composition is changed, changing the wavelength of circularly polarized light selectively reflected. When the applied voltage is removed, the structure of the chiral agent which is changed by oxidation-reduction reaction is returned to the original structure due to reverse reaction, and thus the period of the helical structure is returned to the original state. In the liquid crystal element of the present embodiment, the reverse reaction suppressing layer separates the liquid crystal composition layer from the counter electrode material layer, and thus the reverse reaction after voltage removal is suppressed, and the period of the helical structure in a state with voltage applied is maintained, thereby obtaining the memory property for reflected color. That is, the “memory property for reflected color” represents that the reflected color changed by applying a voltage is maintained after voltage application is stopped. The maintenance time of the changed reflected color may be, for example, 3 seconds to 30 seconds.

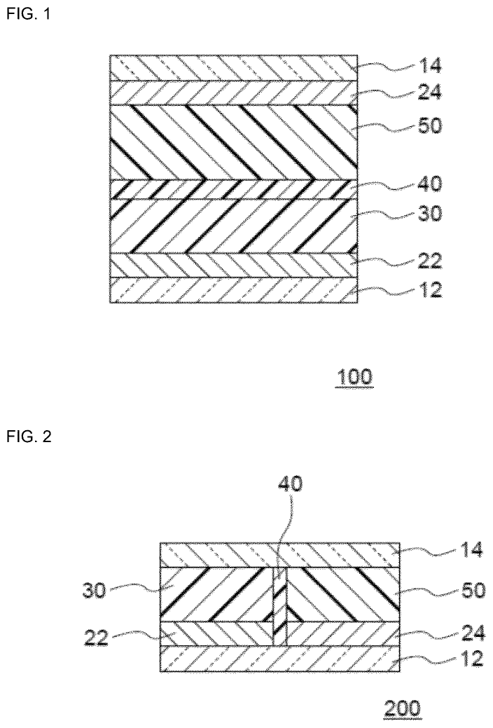

An example of the configuration of the liquid crystal element is described with reference to the drawings. FIG. 1 is a schematic sectional view showing an example of the configuration of the liquid crystal element. A liquid crystal element 100 includes a first electrode 22, a counter electrode material layer 30 disposed on the first electrode 22, a reverse reaction suppressing layer 40 disposed on the counter electrode material layer 30, a liquid crystal composition layer 50 disposed on the reverse reaction suppressing layer 40, and a second electrode 24 disposed on the liquid crystal composition layer 50. The first electrode 22 is disposed on a first substrate 12, and the second electrode 24 is disposed on a second substrate 14. As shown in FIG. 1, the first electrode 22 and the second electrode 24 are disposed to face each other. The counter electrode material layer 30 disposed in contact with the first electrode 22 and the liquid crystal composition layer 50 disposed in contact with the second electrode 24 are laminated with the reverse reaction suppressing layer 40 interposed therebetween.

FIG. 2 is a schematic sectional view showing another example of the configuration of the liquid crystal element. A liquid crystal element 200 includes a first electrode 22, a counter electrode material layer 30 disposed on the first electrode 22, a second electrode 24, a liquid crystal composition layer 50 disposed on the second electrode 24, and a reverse reaction suppressing layer 40 disposed to separate the counter electrode material layer 30 from the liquid crystal composition layer 50. The first electrode 22 and the second electrode 24 are disposed on a first substrate 12 to be separated from each other by the reverse reaction suppressing layer 40. A second substrate 14 is disposed on the counter electrode material layer 30, the liquid crystal composition layer 50, and the reverse reaction suppressing layer 40. The counter electrode material layer 30 disposed in contact with the first electrode 22 and the liquid crystal composition layer 50 disposed in contact with the second electrode 24 are disposed with the reverse direction suppressing layer 40 interposed therebetween in the direction perpendicular to the lamination direction of the liquid crystal element 200.

### Liquid Crystal Composition Layer

The liquid crystal composition layer includes a liquid crystal composition containing the chiral agent capable of oxidation-reduction reaction, the liquid crystalline compound, and the electrolyte. The liquid crystal composition can exhibit, for example, a cholesteric liquid crystal. Also, the liquid crystal composition shows selective reflection, and the selective reflection wavelength can be changed by the oxidation-reduction reaction of the chiral agent due to an electric field.

The liquor crystal composition contains the chiral agent capable of oxidation-reduction reaction (may be simply referred to as the “chiral agent” hereinafter). The liquid crystal composition may contain the chiral agent as a liquid crystalline compound, and may be configured by containing, as a host liquid crystal, a liquid crystalline compound different from the chiral agent and containing the chiral agent as a chiral dopant. The content of the chiral agent in the liquid crystal composition is, for example, 0.1 mol % to 10 mol %, and may be preferably 0.5 mol % to 5 mol %. The details of the chiral agent are described later.

Examples of the liquid crystalline compound constituting the liquid crystal composition include a liquid crystalline compound showing a nematic phase, and a liquid crystalline compound showing a smectic phase, and a liquid crystalline compound showing a nematic phase is preferred. Specific examples of the liquid crystalline compound include an azomethine compound, a cyanobiphenyl compound, a cyanophenyl ester compound, a fluorine-substituted phenyl ester compound, a cyclohexanecarboxylic acid phenyl ester compound, a fluorine-substituted cyclohexanecarboxylic acid phenyl ester compound, a cyanophenyl cyclohexane compound, a fluorine-substituted phenyl cyclohexane compound, a cyanophenyl pyrimidine compound, a fluorine-substituted phenyl pyrimidine compound, an alkoxyphenyl pyrimidine compound, a fluorine-substituted alkoxyphenyl pyrimidine compound, a phenyl dioxane compound, a tolane-based compound, a fluorine-substituted tolane-based compound, an alkenyl cyclohexyl benzonitrile compound, and the like. For the details of the liquid crystalline compound, it is possible to refer to, for example, the description in Liquid Crystal Device Handbook, Nikkan Kogyo Shimbunsha 1989, p. 154-192 and 715-722, etc. edited by the 142nd Committee of the Japan Society for the Promotion of Science.

Specific examples of the liquid crystalline compound include liquid crystalline compounds such as 4-cyano-4′-pentyloxybiphenyl (5OCB), 4-cyano-4′-pentylbipheny; (5CB), and the like. The content of the liquid crystalline compound in the liquid crystal composition may be the balance excluding the chiral agent and the electrolyte and various additives added according to demand.

The liquid crystal composition may further contain the electrolyte. The liquid crystal composition can be imparted with sufficient conductivity by containing the electrolyte, and thus oxidation-reduction reaction of the chiral agent (for example, a compound represented by formula (1)) is more facilitated. The electrolyte may be a supporting electrolyte which constitutes the liquid crystal composition and may be selected from compounds having high solubility in a host liquid crystal. A supporting electrolyte (for example, nBu₄NPF₆, nBu₄NBF₄, nBu₄NClO₄, and the like) generally used in electrochemistry, an ionic liquid, or the like cam be used as the electrolyte. Examples of the ionic liquid include 1-ethyl-3-methylimidazolium triflate, 1-ethyl-3-methylimidazolium hexafluorophosphate, and the like. The electrolyte contained in the liquid crystal composition may be one type or a combination of two or more types. The content of the electrolyte in the liquid crystal composition may be, for example, 0.1 mol % to 30 mol % and preferably 0.5 mol % to 15 mol %.

For the purpose of changing the physical properties (for example, the temperature range of a liquid crystal phase) of the host liquid crystal within a desired range, promoting oxidation-reduction reaction, or the like, various compounds such as a crystalline or non-crystalline compound can be added to the liquid crystal composition. Also, additives such as an ultraviolet absorber, an antioxidant, etc. may be contained.

The thickness of the liquid crystal composition layer in the liquid crystal element may be, for example, 1 μm to 100 μm and preferably 1 μm to 50 μm.

### Counter Electrode Material Layer

The counter electrode material layer is configured by containing a counter electrode material as a substance capable of oxidation-reduction reaction. The counter electrode material may be a substance which is oxidized/reduced corresponding to the oxidation-reduction reaction of the chiral agent. The counter electrode material may be a substance capable of reversible oxidation-reduction reaction, and may be either an organic material or an inorganic material. Specific examples of the counter electrode material include organic materials such as poly(3,4-ethylenedioxythiophene) (PEDOT), polypyrrole, polyaniline, and the like; and inorganic materials such as Prussian blue, tungsten oxide, and the like. The counter electrode material preferably may contain at least one selected from the group including poly(3,4-ethylenedioxythiophene) (PEDOT) and Prussian blue. The organic material such as PEDOT or the like applied to the counter electrode material may be a block copolymer with polyethylene glycol (PEG) or the like. Examples of a block copolymer of PEDOT and PEG include Aedotron™ (manufactured by Sigma-Aldrich Co. LLC) and the like. The content of the counter electrode material in the counter electrode material layer may be, for example, 0.1% by mass or more and preferably 0.5% by mass or more or 10% by mass or less.

The counter electrode material layer may further contain a conductive substance in addition to the substance capable of oxidation-reduction reaction. Examples of the conductive substance include conductive polymers such as polystyrene sulfonate (PSS), polypyrrole, polyaniline, and the like, supporting electrolytes (for example, nBu₄NPF₆, nBu₄NBF₄, nBu₄NClO₄, and the like) generally used in electrochemistry, and the like.

When the counter electrode material layer contains the substance capable of oxidation-reduction reaction and the conductive substance, the counter electrode material layer may contain these substances as a composite. Examples of the composite include PEDOT/PSS and the like. A commercial product may be used as the composite such as PEDOT/PSS or the like. Examples of the commercial product include Orgacon™ and Aedotron™ (the above manufactured by Sigma-Aldrich Co. LLC) and the like. When the counter electrode material layer contains the composite of the substance capable of oxidation-reduction reaction and the conductive substance, the content of the composite in the counter electrode material layer may be, for example, 0.1% by mass or more and preferably 0.5% by mass or more or 10% by mass or less. In an aspect, the counter electrode material layer may be composite of the composite of the substance capable of oxidation-reduction reaction and the conductive substance.

The thickness of the counter electrode material layer in the liquid crystal element may be, for example, 10 nm to 1 mm and preferably 100 nm to 100 μm.

### Reverse Reaction Suppressing Layer

The reverse reaction suppressing layer suppresses the return to the original structure of the chiral agent due to reverse reaction from the structure changed by oxidation-reduction reaction. The reverse reaction suppressing layer may be configured to enable to suppress the contact between the chiral agent and the counter electrode material. For example, the reverse reaction suppressing layer may be configured to suppress the permeation of the chiral agent. The reverse reaction suppressing layer may be composed of a porous material or composed of a nonporous material (for example, a solid material). The reverse reaction suppressing layer may be configured by containing a resin and may be configured by containing a resin which enables to form the reverse reaction suppressing layer by coating on the counter electrode material layer. Examples of the resin which can constitute the reverse reaction suppressing layer include insulating resins such as polyethylene, polypropylene, an epoxy resin, an acrylic resin, and the like, a cationic or anionic ion exchange resin, a covalent organic framework, and the like. Specific examples of the ion exchange resin include Nafion™, polyallylamine, and the like. Also, the reverse reaction suppressing layer may be configured by containing a gel electrolyte material, a solid electrolyte material, or the like.

The thickness of the reverse reaction suppressing layer in the liquid crystal element may be, for example, 10 nm to 1 mm and preferably 100 nm to 100 μm.

### Electrode

The electrode includes the first electrode disposed in contact with the counter electrode material layer and the second electrode disposed in contact with the liquid crystal composition layer. The electrode may be formed on, for example, a substrate described later. The electrode may be either a transparent electrode or untransparent electrode. Examples of a material which forms the transparent electrode include indium oxide, indium tin oxide (ITO), tin oxide, silver nanorods, carbon nanotubes, conductive resins such as polystyrene sulfonate and the like, and the like. The transparent electrode can be formed by a sputtering method, a sol-gel method, or a printing method. For example, a GC electrode or the like can be used as the untransparent electrode.

If required, rubbing treatment may be performed on the surface of the electrode disposed in contact with the liquid crystal composition layer. The rubbing treatment more improves the alignment properties of liquid crystal.

### Substrate

The liquid crystal element may further include a pair of substrates. The pair of substrates may be disposed, for example, so as to hold the liquid crystal composition layer, the reverse reaction suppressing layer, and the counter electrode material layer.

Glass, plastic, or the like may be used as the material of the substrates constituting the liquid crystal element. Examples of plastic used for the substrates include an acrylic resin, a polycarbonate resin, an epoxy resin, a polyester resin, a polyamide resin, a polyolefin resin, a polyether resin, a polysulfide resin, a polysulfone resin, a polyester sulfone resin, a polyether imide resin, a polyimide resin, and the like.

At least one of the pair of substrates constituting the liquid crystal element may have light transmission. When the substrate has light transmission, the haze value thereof may be, for example, 3% or less and preferably 2% or less or 1% or less. Also, the total light transmittance of the light transmissive substrate may be, for example, 70% or more and preferably 80% or more or 90% or more.

One of the substrates may be light non-transmissive. When a light non-transmissive substrate is used as the substrate, a black substrate not having light reflectivity can be used on the non-display surface side. An example of the black substrate is a plastic substrate containing an inorganic pigment, such as carbon black or the like, added thereto.

### Chiral Agent

The liquid crystal composition contains at least one chiral agent capable of oxidation-reduction reaction. The chiral agent may constitute, as a chiral dopant, the liquid crystal composition. The chiral agent may be, for example, a compound having a structure site serving as an asymmetric source and an oxidation-reduction reaction site. An example of the structure site serving as the asymmetric source is an optically active skeleton having asymmetric carbons, such as a binaphthyl skeleton or the like. Examples of the oxidation-reduction reaction site include ferrocene, a ferrocene derivative, an arylamine derivative, and the like. The chiral agent may contain a compound having a binaphthyl skeleton and an oxidation-reduction reaction site and may contain, for example, a compound represented by formula (1) below.

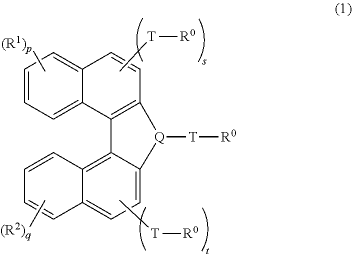

In the formula (1), R⁰s each independently represent a functional group capable of oxidation-reduction reaction, and s and t each independently represent an integer of 0 to 6. R¹ and R² each independently represent a substituent. In addition, p+s and q+t each independently represent an integer of 0 to 6. Ts each independently represent a divalent linking group composed of at least one selected from the group including a carbonyl group, an oxygen atom, an imino group, and an alkylene group. Q represents a trivalent linking group composed of at least one selected from the group including an oxygen atom, a nitrogen atom, a carbon atom, a phosphorus atom, a sulfur atom, and a hydrogen atom.

Examples of the functional group capable of oxidation-reduction reaction represented by R⁰ include ferrocene, a ferrocene derivative, an aryl amine derivative, and the like, and at least one selected from the group including these may be contained.

In addition, s and t each independently represent an integer of 0 to 6. Preferably, it may be an integer of 5 or less or an integer of 2 or less, and an integer of 1 or more. In addition, p and q may each independently represent an integer or 0 to 6, and preferably p and q may be each an integer of 5 or less or 2 or less and an integer of 1 or more. Further, p+s and q+t each independently represent an integer of 0 to 6. Preferably, p+s and q+t may be each an integer of 5 or less or an integer of 2 or less, and an integer of 1 or more.

R¹ and R² each independently represent a substituent. The substituent represented by R¹ or R² may be at least one substituent selected from the group including a substituted or unsubstituted hydrocarbon group, a nitro group, a cyano group, a halogen atom, a hydroxy group, an alkoxy group, an acyl group, an alkoxycarbonyl group, a carboxy group, an aliphatic amino group, and an aromatic amino group. When in the compound represented by the formula (1), there are plural substituents represented by R¹ or R², the substituents may be the same or different.

A hydrocarbon group as the substituent may be either an aliphatic group or an aromatic group. The aliphatic group may be either a saturated aliphatic group or an unsaturated aliphatic group. Also, the aliphatic group may be linear, branched, or cyclic, or may be a combination of these. The number of carbon atoms of an aliphatic group may be, for example, 1 to 20 carbon atoms and preferably 1 to 10 or 1 to 6. Examples of the substituent in the aliphatic group include a halogen atom, an aryl group, an alkoxy group, and the like. The number of carbon atoms of an aromatic group may be, for example, 6 to 18 and preferably 6. Examples of the substituent in the aromatic group include a halogen atom, an aliphatic group having 1 to 20 carbon atoms, an alkoxy group, an acyl group, an alkoxycarbonyl group, and the like.

The halogen atom as the substituent may contain a fluorine atom, a chlorine atom, a bromine atom, or the like. The alkoxy group as the substituent may have an aliphatic group having 1 to 20 carbon atoms and preferably an aliphatic group having 1 to 10 carbon atoms. The acyl group as the substituent may have an aliphatic group having 1 to 20 carbon atoms and preferably an aliphatic group having 1 to 6 carbon atoms. The alkoxycarbonyl group as the substituent may have an aliphatic group having 1 to 20 carbon atoms and preferably an aliphatic group having 1 to 6 carbon atoms.

The aliphatic group in the aliphatic amino group as the substituent may be either a saturated aliphatic group or an unsaturated aliphatic group. The aliphatic group may be linear, branched, or cyclic, or may be a combination of these. The number of carbon atoms of an aliphatic group may be, for example, 1 to 20 carbon atoms and preferably 1 to 10 or 1 to 6. The aliphatic amino group mya be a monosubstituted aliphatic amino group having one aliphatic group or a disubstituted aliphatic group having two aliphatic groups. The aliphatic amino group may further have a substituent in an aliphatic group portion. Examples of a substituent in the aliphatic group include a halogen atom, an aryl group, an alkoxy group, an alkylamino group, an arylamino group, and the like. The number of substituents in the aliphatic group may be, for example, 0 to 20, and preferably 10 or less.

An aromatic group in the aromatic amino group as the substituent may be an aromatic hydrocarbon group or an aromatic heterocyclic group. The number of carbon atoms of the aromatic hydrocarbon group may be, for example, 6 to 18 and preferably 6 to 12. The aromatic hydrocarbon group may contain at least one selected from the group including a phenyl group, a naphthyl group, and an anthracenyl group. Also, the aromatic heterocyclic group may contain, as a heteroatom, at least one selected from the group including a nitrogen atom, an oxygen atom, and a sulfur atom. The number of members of the aromatic heterocyclic group may be, for example, 5 to 10, and preferably 6 or less. The aromatic heterocyclic group may contain at least one selected from the group including a pyridyl group, a furyl group, and a thienyl group. The aromatic amino group mya be a monosubstituted aromatic amino group having one aromatic group or a disubstituted aromatic amino group having two aromatic groups. The aromatic amino group may further have a substituent group in an aromatic group portion. Examples of a substituent in the aromatic group include a halogen atom, an aryl group, an alkoxy group, an alkylamino group, an arylamino group, an alkyl group, and the like. The number of substituents in the aromatic group may be, for example, 0 to 8, and preferably 5 or less.

Ts each independently represent a divalent linking group formed of at least one selected from the group including a carbonyl group, an oxygen atom, an imino group, and an alkylene group. The imino group in T may be substituted by a hydrocarbon group. The hydrocarbon group substituted in the imino group is the same as the hydrocarbon group in the substituent as R¹ and R². The alkylene group in T may be linear, branched, or cyclic, or may be a combination of these. The number of carbon atoms of the alkylene group in T may be, for example, 1 to 20 and preferably 10 or less or 6 or less. The divalent linking group represented by T may be a carbonyl group, an oxygen atom, an imino group, or an alkylene group and may contain, for example, an ester bond formed by bonding of a carbonyl group and an oxygen atom, and may contain an amido bond, a urea bond, or the like formed by bonding of a carbonyl group and an imino group, may contain a urethane bond or the like formed by bonding of a carbonyl group, an imino group, and an oxygen atom, or may contain an ether bond formed by bonding of an oxygen atom and an alkylene group. When there are plural divalent linking groups represented by T in the aromatic amine group, these groups may be the same or different.

The divalent linking group represented by T may be formed by containing at least a carbonyl group. Specific examples of the divalent linking group represented by T include a carbonyl group, an oxygen atom, an imino group, an alkylene group, a carbonyloxy group, an oxycarbonyl group, an alkylene carbonyloxy group, an alkylene oxycarbonyl group, a carbonyloxy alkylene group, an oxycarbonyl alkylene group, an iminocarbonyl group, an alkylene iminocarbonyl group, a carbonylimino group, a carbonylimino alkylene group, an alkyleneoxy group, an oxyalkylene group, an iminocarbonyl imino group, an oxycarbonylimino group, an iminocarbonyloxy group, and the like. Preferred examples of the divalent linking group represented by T include a carbonyloxy group, an oxycarbonyl group, an oxygen atom, and the like.

Q represents a trivalent linking group composed of at least one selected from the group including an oxygen atom, a nitrogen atom, a carbon atom, a phosphorus atom, a sulfur atom, and a hydrogen atom. Q may be, for example, a trivalent linking group represented by formula (2a) or (2b) below.

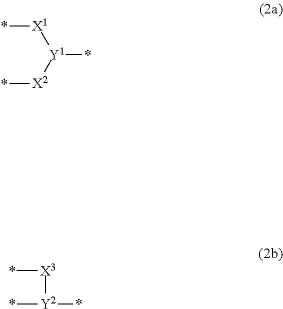

In the formulae (2a) and (2b), * represents a bonding position to another atom, and X¹, X², and X³ each independently contain at least one selected from the group including an oxygen atom, a sulfur atom, —C(R³)(R⁴)—, and —N(R⁵)—. R³, R⁴, and R⁵ each independently represent a hydrogen atom, a substituted or unsubstituted alkyl group, or a substituted or unsubstituted aromatic group. Y¹ and Y² each independently represent one selected from the group including a substituted or unsubstituted alkanetriyl group, a nitrogen atom, and —P(═O)(O—)—.

An alkyl group represented by R³, R⁴, or R⁵ may be linear, branched, or cyclic, or may be a combination of these. The number of carbon atoms of an alkyl group represented by R³, R⁴, or R⁵ may be, for example, 1 to 20 and preferably 6 or less. An aromatic group represented by R³, R⁴, or R⁵ is formed by removing one hydrogen atom from an aromatic hydrocarbon compound or an aromatic heterocyclic compound. The aromatic hydrocarbon compound or aromatic heterocyclic compound is as described above. The substituent in R³, R⁴, or R⁵ is the same as the substituent in R¹ and R².

An alkanetriyl group represented by Y¹ or Y² is formed by removing three hydrogen atoms from an alkane. The number of carbon atoms of an alkane which forms the alkanetriyl group may be, for example, 1 to 20 and preferably 6 or less. The substituent in Y¹ or Y² is the same as the substituent in R¹ and R².

Examples of the trivalent linking group represented by the formula (2a) include linking groups below, but the present disclosure is not limited to these. In the trivalent linking group represented by the formula (2a), X¹ and X² may be bonded to a binaphthyl site in the formula (1), and Y¹ may be bonded to T in the formula (1).

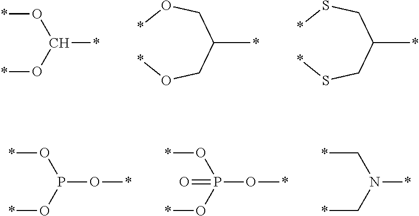 [SMILES: *OC(*)O* ; *OCC(*)CO* ; *SCC(*)CS* ; *OP(O*)O* ; *OP(=O)(O*)O* ; *CN(*)C*]

Specific examples of the trivalent linking group represented by the formula (2b) include linking groups below, but the present disclosure is not limited to these. In the trivalent linking group represented by the formula (2b), X³ and Y² may be bonded to a binaphthyl site in the formula (1), and Y² may be bonded to T in the formula (1).

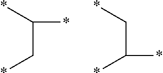

The trivalent linking group represented by Q may be preferably represented by the formula (2a), and more preferably may contain oxygen atoms as X¹ and X² in the formula (2a) and a propane-1, 2, 3-triyl group as Y¹.

In an aspect, a compound represented by the formula (1) may be a compound represented by formula (1a).

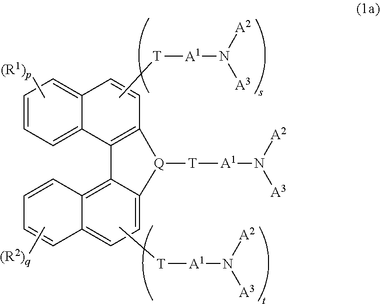

In the formula (1a), R¹, R², T, Q, s, t, p, and q have the same meanings as those in the formula (1). In the formula, A¹s each independently represent a substituted or unsubstituted alkylene group or a substituted or unsubstituted divalent aromatic group. In addition, A²s and A³s each independently represent a substituted or unsubstituted alkyl group or a substituted or unsubstituted aromatic group. At least one of A¹, A², and A³ represents an aromatic group.

An alkylene group represented by A¹ may be linear, branched, or cyclic, or may be a combination of these. The number of carbon atoms of the alkylene group represented by A¹ may be, for example, 1 to 20 and preferably 1 to 10. A divalent aromatic group represented by A¹ is formed by removing two hydrogen atoms from an aromatic hydrocarbon compound or an aromatic heterocyclic compound. The number of carbon atoms of the aromatic hydrocarbon compound may be 6 to 18 and preferably 6. The aromatic hydrocarbon compound may contain at least one selected from the group including benzene, naphthalene, and anthracene. Also, the aromatic heterocyclic compound may contain at least one selected from the group including a nitrogen atom, an oxygen atom, and a sulfur atom as a heteroatom. The number of members of the aromatic heterocyclic compound may be, for example, 5 to 10, and preferably may be 6 or less. The aromatic heterocyclic compound may contain at least one selected from the group including pyridine, furane, and thiophene. When there are plural divalent aromatic groups in the alkylene group represented by A¹ in an aromatic amine compound, they may be the same or different.

The alkylene group or divalent aromatic group represented by A¹ may have a substituent. The substituent in A¹ is the same as the substituents in R¹ and R². The number of substitutions of the alkylene group or divalent aromatic group represented by A¹ may be, for example, 0 to 20 and preferably 4 or less.

An alkyl group represented by A² or A³ may be linear, branched, or cyclic, or may be a combination of these. The number of carbon atoms of the alkyl group represented by A² or A³ may be, for example, 1 to 20 and preferably 1 to 6. An aromatic group represented by A² or A³ is formed by removing one hydrogen atom from an aromatic hydrocarbon compound or an aromatic heterocyclic compound. The details of the aromatic hydrocarbon compound or aromatic heterocyclic compound are the same as the aromatic hydrocarbon compound or aromatic heterocyclic compound for A¹. When there are plural alkyl groups or aromatic groups represented by A² or A³ in the compound (aromatic amine compound represented by the formula (1a), they may be the same or different.

The alkyl group or aromatic group represented by A² or A³ may have a substituent. The substituent in A² or A³ is the same as the substituents in R¹ and R². The number of substitutions of the alkyl group or aromatic group represented by A² or A³ may be, for example, 0 to 20 and preferably 5 or less.

At least one of the aromatic groups represented by A² or A³ may have a substituent, and may have an aromatic amino group as a substituent. The aromatic amino group substituted in the aromatic group represented by A² or A³ may be an amino group having two aromatics, that is, a disubstituted aromatic amino group, and the aromatic group in the aromatic amino group may further have a substituent. Examples of the substituent in the aromatic group include a halogen atom, an aryl group, an alkoxy group, an alkylamino group, an arylamino group, an alkyl group, and the like. The number of substitutions of the aromatic group may be, for example, 0 to 9 and preferably 1 to 5.

At least one of A¹, A², and A³ represents an aromatic group, preferably at least two may be aromatic groups, and more preferably three may be aromatic groups. In addition, at least A¹ of A¹, A², and A³ may be an aromatic group, or at least one of A² and A³ may be an aromatic group.

The compound represented by the formula (1a) can be produced, for example, as follows. The compound represented by the formula (1a) can be produced by introducing a trivalent linking group, represented by Q, by reacting a dihaloalkane having a substituent with 1,1′-bi(2-naphthol), and linking an aromatic amine derivative to the trivalent linking group, represented by Q, by condensation reaction, substitution reaction, coupling reaction, or the like. Also, the aromatic amine derivative can be linked onto the naphthyl ring by using 1,1′-bi(2-naphthol) having a proper substituent on the naphthyl ring. For the details of the compound represented by the formula (1a), it is possible to refer to, for example, the specification of Japanese Patent Application No. 2022-177592.

In an aspect, the compound represented by the formula (1) may be a compound represented by formula (1b) below.

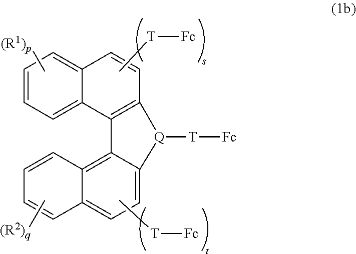

In the formula (1b), R¹, R², T, Q, s, t, p, and q have the same meanings as those in the formula (1). Fc each independently represent ferrocene of a ferrocene derivative. Ferrocene of a ferrocene derivative represented by Fc may be, for example, a functional group represented by formula (3) below.

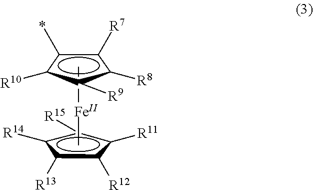

In the formula (3), R⁷, R⁸, R⁹, R¹⁰, R¹¹, R¹², R¹³, R¹⁴, and R¹⁵ each independently represent a hydrogen atom or a substituent, and + represents a bond position bonded to T in the formula (1b).

Examples of a substituent represented by R⁷, R⁸, R⁹, R¹⁰, R¹¹, R¹², R¹³, R¹⁴, or R¹⁵ include an alkyl group, a halogen atom, an alkoxy group, and the like. An alkyl group represented by A⁷ or the like may be linear, branched, or cyclic, or may be a combination of these. The number of carbon atoms of an alkyl group may be, for example, 1 to 20 and preferably 1 to 10 or 1 to 8. Examples of a halogen atom represented by A⁷ or the like include a fluorine atom, a chlorine atom, a bromine atom, an iodine atom, and the like. An alkyl group portion of an alkoxy group represented by A⁷ or the like may be linear, branched, or cyclic, or may be a combination of these, and may further have a substituent. The number of carbon atoms of an alkyl portion of the alkoxy group may be, for example, 1 to 20 and preferably 1 to 10 or 1 to 8. Examples of a substituent in the alkoxy group include an alkoxy group having 1 to 6 carbon atoms, an aryloxy group, and the like.

For the compound represented by the formula (1b), it is possible to refer to the description of Japanese Unexamined Patent Application Publication No. 2019-151597.

The liquid crystal element may further include other members, for example, a barrier film, an ultraviolet absorption layer, an antireflection layer, a hard coat layer, an antifouling layer, an organic interlayer insulating layer, a metal reflector, a retardation plate, an alignment film, and the like. These may be used alone or in combination of two or more.

The liquid crystal element can be driven by using a simple matrix drive system or an active matrix drive system using a thin film transistor (TFT) or the like.

In the liquid crystal element, the absolute value of driving voltage may be, for example, 0.1 V to 20 V, and preferably 0.3 V to 15 V or 0.5 V to 1.0 V.

### Display Device

A display device includes the liquid crystal element described above. A reflection-type display device driven by a simple matrix drive system or an active matrix drive system can be configured by providing the liquid crystal element configured to be capable of color adjustment by the voltage applied to a liquid crystal layer.

### Dimmer Device

A dimmer device includes the liquid crystal element described above. A dimmer device which exhibits the reflected light color or transmitted light color of desired circularly polarized light can be configured by providing the liquid crystal element configured to be capable of color adjustment by the voltage applied to a liquid crystal layer.

The present disclosure also includes as other aspects the use of the chiral agent in producing the liquid crystal element, and the chiral agent used in the liquid crystal element.

### EXAMPLES

The present disclosure is more specifically described below by using examples, but the present disclosure is not limited to these examples.

### Production Example 1

### Synthesis of Precursor TPA-OMe-COOH

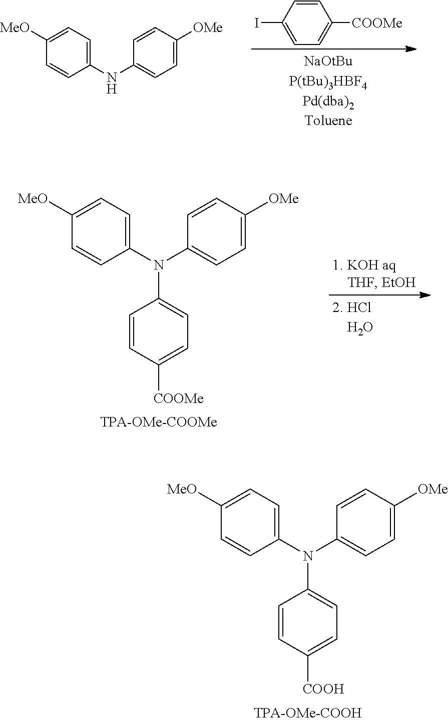 [SMILES: COc1ccc(Nc2ccc(OC)cc2)cc1 ; COC(=O)c1ccc(I)cc1 ; COC(=O)c1ccc(N(c2ccc(OC)cc2)c2ccc(OC)cc2)cc1 ; COc1ccc(N(c2ccc(OC)cc2)c2ccc(C(=O)O)cc2)cc1]

As shown in the scheme described above, to a three-neck flask in a nitrogen atmosphere, were added 1.15 g (5.0 mmol) of 4,4′-dimethoxydiphenylamine (manufactured by Tokyo Chemical Industry Co., Ltd.), 1.40 g (5.2 mmol) of methyl 4-iodobenzoate (manufactured by Tokyo Chemical Industry Co., Ltd.), 0.72 g (7.5 mmol) of sodium tert-butoxide (manufactured by Tokyo Chemical Industry Co., Ltd.), 0.15 g (0.5 mmol) of tri-tert-butyl phosphonium tetrafluoroborate (manufactured by Tokyo Chemical Industry Co., Ltd.), 0.15 g (0.25 mmol) of bis(dibenzylideneacetone) palladium (0) (manufactured by Fujifilm Wako Pure Chemical Corporation), and 100 mL of toluene (super dehydrated) (manufactured by Fujifilm Wako Pure Chemical Corporation), and the resultant mixture was stirred for 7 hours while being heated under reflux and then stirred under the condition of room temperature. One day after, the reaction solution was slowly added to 250 mL of a 1M aqueous ammonia solution, terminating the reaction. Then, the solution was fileted with celite and washed with toluene. An aqueous layer was removed by liquid separation, and then an organic layer was further separated with saturated saline and dehydrated with magnesium sulfate. Then, the solvent was removed by an evaporator, and the residue was dried under reduced pressure, obtaining reddish brown oily substance TPA-OMe-COOMe.

The resultant oily substance TPA-OMe-COOMe was dissolved in 50 mL of THF (manufactured by Fujifilm Wako Pure Chemical Corporation) and 50 mL of ethanol (manufactured by Fujifilm Wako Pure Chemical Corporation), and 50 mL of a 2M aqueous potassium hydroxide solution was added to the resultant solution and heated under reflux for 1 hour. After allowing to cool, THF and ethanol were removed by an evaporator, and then 100 mL of ultrapure water was added, and a 2M aqueous HCl solution was slowly added until the solution became acidic, producing a yellowish-white precipitate. Then, the yellowish-white precipitate was dissolved by adding 200 mL of dichloromethane (manufactured by Fujifilm Wako Pure Chemical Corporation), and an aqueous layer was removed by a liquid separating operation. Then, liquid separation was performed using saturated saline, and an organic layer was dehydrated with magnesium sulfate. Then, the solvent was removed by an evaporator, and the residue was dried under reduced pressure, producing a yellowish-brown oily substance. A desired compound was isolated (Rf=0.5) from the oily substance by a silica gel column using ethyl acetate:hexane=1:1 as a developing solvent. The solvent was removed by an evaporator, and the residue was dried under reduced pressure, producing 400 mg of precursor TPA-OMe-COOH as a white powder. The resultant compound was identified by using 1H-NMR.

¹H-NMR (400 MHZ, CDCl₃): δ (ppm) 7.84 (d, 2H), 7.11 (d, 4H), 6.88 (d, 4H), 6.81 (d, 2H), 3.82 (s, 6H)

### Synthesis of Compound BN-TPA-OMe

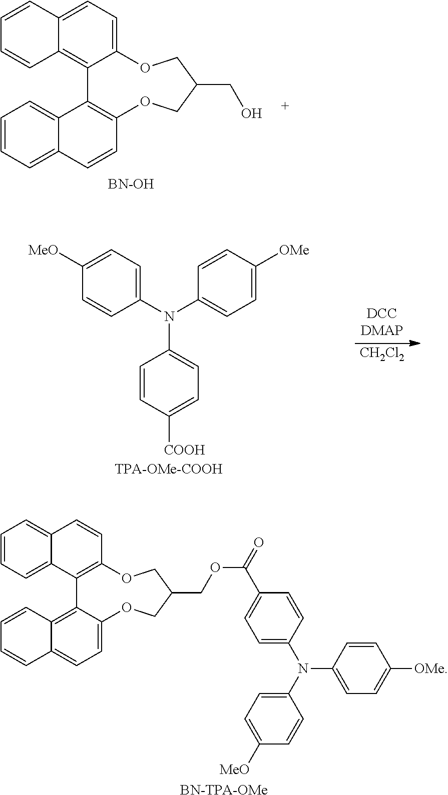

To a tree-neck flask in a nitrogen atmosphere, were added 0.18 g (0.5 mmol) of the compound TPA-OMe-COOH, 0.18 g (0.5 mmol) of BN—OH, 0.14 g (0.75 mmol) of 1-(3-dimethylaminopropyl)-3-ethyl carbodiimide hydrochloride (manufactured by Tokyo Chemical Industry Co., Ltd.), 0.06 g (0.5 mmol) of 4-dimethylaminopyridine (manufactured by Tokyo Chemical Industry Co., Ltd.), and 30 mL of dichloromethane (manufactured by Fujifilm Wako Pure Chemical Corporation), and the resultant mixture was stirred for 1 day at room temperature. The reaction solution was subjected to extraction by adding dichloromethane and liquid separation using saturated saline, and then an organic layer was dehydrated with magnesium sulfate. The solvent was removed by an evaporator, and then the residue was dried under reduced pressure, producing a light yellow powder. A desired compound BN-TPA was purified (Rf=0.5) by a silica gel column using ethyl acetate:hexane=1:1 as a developing solvent. The solvent was removed by an evaporator, and then the residue was dried under reduced pressure, producing 0.22 g of final desired compound BN-TPA as a yellowish-white powder. The resultant compound was identified by using 1H-NMR and ESI-MS. In addition, BN—OH was synthesized with reference to a known method (for example, J. Am. Chem. Soc., 2018, 140, 10946).

¹H-NMR (400 MHZ, CDCl₃): δ (ppm) 7.96 (dd, 2H), 7.88 (d, 2H), 7.74 (d, 2H), 7.56 (d, 1H), 7.41 (d, 1H) 7.35-7.39 (m, 2H), 7.21-7.25 (m, 2H+2H), 7.10 (d, 4H), 6.87 (d, 4H), 6.79 (d, 2H), 4.73 (dd, 1H), 4.61 (d, 1H), 4.10-4.33 (m, 4H), 3.81 (s, 6H), 2.61-2.66 (m, 1H)

ESI-MS: m/z calc for C₄₅H₃₇NO₆: 688.27 [M+H]⁺; found 688.27.

### Example 1

The compound BN-TPA-OMe was dissolved in a methylene chloride solution of host liquid crystal molecules prepared by mixing 4-cyano-4′-pentyloxybiphenyl and 4-cyano-4′-pentylbiphenyl at 7:3 so that the final concentration was 3 mol %, and 1-ethyl-3-methylimidazolium triflate was added to the resultant solution and then concentrated under reduced pressure, preparing a liquid crystal composition.

A liquid crystal element having a configuration shown in FIG. 1 was formed by using the prepared liquid crystal composition. PEDOT/PSS was spin-coated on one ITO glass of a cell having a cell thickness of 10 μm and composed of ITO glass, forming a film as a counter electrode material layer. Then, a Nafion™ film was formed by spin coating on the counter electrode material layer, forming a reverse reaction suppressing layer. The liquid crystal composition prepared as described above was introduced into the cell having the counter electrode material layer and reverse reaction suppressing layer formed therein, forming a liquid crystal element of Example 1.

### Comparative Example 1

A liquid crystal element of Comparative Example 1 was formed by the same method as in Example 1 except that a Nafion™ film was not formed on a counter electrode material layer.

### Evaluation 1

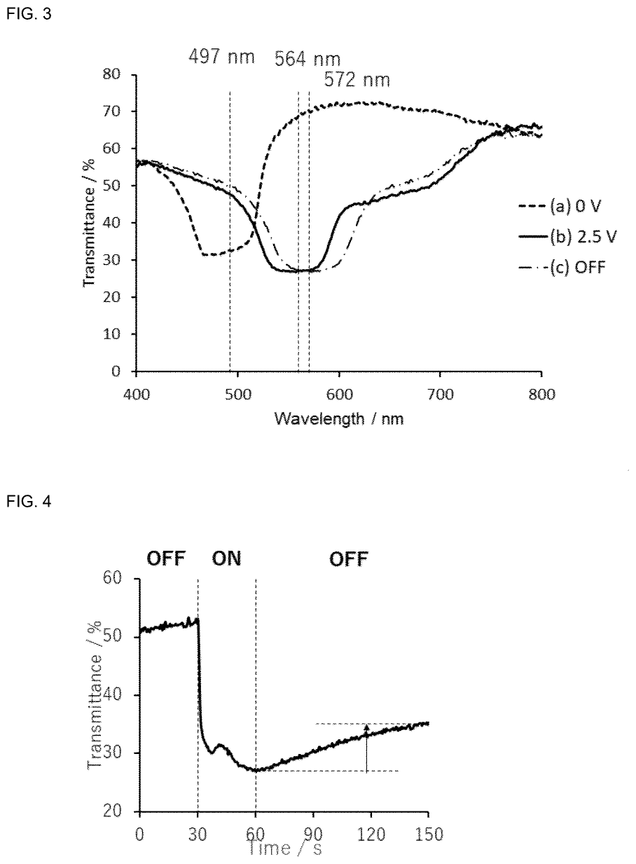

With respect to the liquid crystal element obtained in Example 1, changes in reflected color were measured by transmission spectra using an ultraviolet-visible spectrophotometer (UV1800 manufactured by Shimadzu Corporation). The results are shown in FIG. 3. (a) A broken line shows a transmission spectrum before application of a voltage, (b) a solid line shows a transmission spectrum during application of a voltage of 2.5 V, and (c) a one-dot chain line shows a transmission spectrum immediately after (30 seconds after) the stop of voltage application.

As shown in FIG. 3, it is found that the transmission spectrum is changed by applying a voltage from a state of no voltage application, and the same transmission spectrum as in a state of voltage application is shown even after the stop of voltage application.

### Evaluation 2

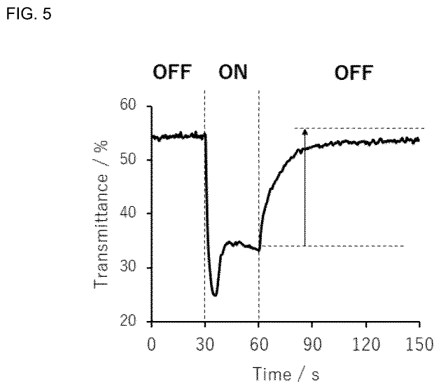

With respect to the liquid crystal element obtained as described above, changes over time were measured at a wavelength of 540 nm using an ultraviolet-visible spectrophotometer (UV1800 manufactured by Shimadzu Corporation). A voltage was applied for 30 seconds after a state of no voltage application, and then voltage application was stopped. Then, changes in transmittance were measured over 90 seconds. The measurement results of the liquid crystal element of Example 1 are shown in FIG. 4, and the measurement results of the liquid crystal element of Comparative Example 1 are shown in FIG. 5.

As shown in FIG. 4, with respect to the liquid crystal element of Example 1, the transmittance at 540 nm was decreased by applying a voltage. After voltage application was stopped, the transmittance was gradually increased, and 90 seconds after, the transmittance was increased by about 30%. As shown in FIG. 5, with respect to the liquid crystal element of Comparative Example 1, the transmittance was rapidly increased after voltage application was stopped, and 90 seconds after, the transmittance was increased by 100%.

All the documents, patent applications, and technical standards described in the present specification are incorporation into the present specification to the same degree as when it is specifically and individually described that each of the documents, patent applications, and technical standards is incorporation by reference.

1. A liquid crystal element comprising:
a liquid crystal composition layer containing:
a chiral agent capable of oxidation-reduction reaction,
a liquid crystalline compound, and
an electrolyte;
a counter electrode material layer containing a substance capable of an oxidation-reduction reaction,
a reverse reaction suppressing layer between the liquid crystal composition layer from the counter electrode material layer, the reverse reaction suppressing layer suppressing the reverse reaction of oxidation-reduction reaction;
a first electrode in electrical contact with the counter electrode material layer; and
a second electrode in electrical contact with the liquid crystal composition layer.

2. The liquid crystal element according to claim 1, wherein the counter electrode material layer is on the first electrode, the reverse reaction suppressing layer is on the counter electrode material layer, the liquid crystal composition layer is on the reverse reaction suppressing layer, and the second electrode is on the liquid crystal composition layer.

3. The liquid crystal element according to claim 1, further comprising a substrate, wherein the first electrode and the second electrode are on the substrate, the counter electrode material layer is on the first electrode, the liquid crystal composition layer is on the second electrode, and the reverse reaction suppressing layer separates the counter electrode material layer from the liquid crystal composition layer and separates the first electrode from the second electrode.

4. The liquid crystal element according to claim 1, wherein a content of the chiral agent in the liquid crystal composition is 0.1 mol % to 10 mol %.

5. The liquid crystal element according to claim 1, wherein the reverse reaction suppressing layer suppresses permeation of the chiral agent.

6. The liquid crystal element according to claim 1, wherein the reverse reaction suppressing layer contains a resin.

7. The liquid crystal element according to claim 6, wherein the resin is selected from insulating resins, cationic ion-exchange resins, anionic ion-exchange resins, and covalent organic frameworks.

8. The liquid crystal element according to claim 1, wherein the reverse-reaction suppressing layer comprises an ion-exchange resin selected from Nafion™ and polyallylamine.

9. The liquid crystal element according to claim 1, wherein the reverse-reaction suppressing layer comprises a gel electrolyte or a solid electrolyte.

10. The liquid crystal element according to claim 1, wherein the reverse-reaction suppressing layer has a thickness from 10 nm to 1 mm.

11. The liquid crystal element according to claim 1, wherein the liquid crystal composition layer has a thickness from 1 μm to 100 μm.

12. The liquid crystal element according to claim 1, wherein the chiral agent contains a compound having a binaphthyl skeleton and an oxidation-reduction reaction site.

13. The liquid crystal element according to claim 12, wherein the oxidation-reduction reaction site comprises ferrocene, a ferrocene derivative or an arylamine derivative.

14. The liquid crystal element of claim 1, wherein the chiral agent is represented by: 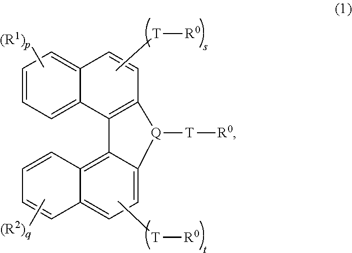
wherein:
R⁰ independently represents a functional group capable of oxidation-reduction reaction,
s and t each independently represent an integer of 0 to 6,
R¹ and R² each independently represent a substituent,
p+s and q+t each independently represent an integer of 0 to 6,
T independently represents a divalent linking group composed of at least one selected from a carbonyl group, an oxygen atom, an imino group, and an alkylene group, and
Q represents a trivalent linking group composed of at least one selected from an oxygen atom, a nitrogen atom, a carbon atom, a phosphorus atom, a sulfur atom, and a hydrogen atom.

15. The liquid crystal element according to claim 1, wherein the counter electrode material layer contains at least one selected from poly(3,4-ethylenedioxythiophene), polyaniline, polypyrrole, Prussian blue, and tungsten oxide.

16. The liquid crystal element according to claim 1, wherein the counter electrode material layer comprises a composite of poly(3,4-ethylenedioxythiophene) and polystyrene sulfonate.

17. The liquid crystal element according to claim 1, wherein the liquid crystal element is configured such that, after application of a voltage sufficient to change a reflection wavelength, a reflected color state is maintained for at least 30 seconds upon removal of the voltage.

18. A display device comprising the liquid crystal element according to claim 1.

19. A dimmer device comprising the liquid crystal element according to claim 1.
